(19) United States
(12) Patent Application Publication
(10) Pub. No.: US 2025/0222547 A1
(43) Pub. Date: Jul. 10, 2025

(54) RESILIENT TOOL HOLDER CLAMP FOR CNC APPLICATIONS

(71) Applicants: David Hill, Hubbard, OH (US); Jeffrey Hill, Youngstown, OH (US)

(72) Inventors: David Hill, Hubbard, OH (US); Jeffrey Hill, Youngstown, OH (US)

(21) Appl. No.: 18/405,305

(22) Filed: Jan. 5, 2024

(51) Int. Cl. B23Q 3/155

(52) U.S. Cl. CPC B23Q 3/1554; B23Q 2003/155411

(57) ABSTRACT

A spring urged tool holder clamp for CNC tool holder magazines that hold a variety of cutting and milling tools for automatic tool changes to a spindle for milling. The individual tool holders are removably secured and held by resilient clamping that frictionally engages the tool holder in place. Independent pivoted opposing engagement jaws on the tool holder clamp diminishes wear and maintains precise positioning of the tool holder critical to the automatic tool loading.

### BACKGROUND OF THE INVENTION

### 1. Technical Field

This invention relates to automatic CNC cutting and milling machines that use cutting tools held in precision milled and balanced tool holders accessible by automatic tool changers in CNC router and milling applications.

### BACKGROUND

Modern manufacturing employs the use of computer numerically controlled (CNC) milling machines to create and finish parts with precision. These machines often include tool holding magazines for positioning and holding a variety of cutting tools in tool holders used in operations that are selectively replaced into the milling spindle for use. The cutting tools are mounted, as noted, in tool holders that have a standardized body shape for swapping the cutting tools in the spindles. It is critical that the tool holders are precisely positioned typically in a tool holder rack or magazine being specifically engaged by a tool holder clamp that allows for automated engagement removal and replacing of the tool holders as needed.

### 2. Description of Prior Art

Prior art tool holder clamps are well known in the industry and typically have a contoured fixed fork made of synthetic resin material. Other examples of such clamps have end relief slots that impart yielding engagement on a tool holder during insertion and removal. Such examples are referred to as ISO30 clamps available from a variety of commercial sources.

### SUMMARY OF THE INVENTION

A tool holder clamp for CNC tool holders that provides for auto adjustable holder engagement as needed. The tool holder clamp has a contoured tool holder receiving opening defined by a pair of positioning and holding armatures. A pair of oppositely disposed independent spring urged end engagement jaws on the respective armatures have corresponding contoured elongated tool holder registration surfaces that adjust as the tool holder is inserted, held and retrieved by the automated system.

### DESCRIPTION OF THE DRAWINGS

FIG. 1 is a perspective view of a tool holder clamp of the invention.

FIG. 2 is a top plan view thereof with portions broken away for illustration.

FIG. 3 is a front elevational view thereof on lines 3-3 of FIG. 1.

FIG. 4 is a right-side elevational view thereof.

FIG. 5 is an enlarged partial top plan view of a left side tool holder clamp engagement jaw in extended position.

FIG. 6 is a rear elevational view of the holder clamp.

FIG. 7 is a bottom plan view of the tool holder clamp.

FIG. 8 is an enlarged top plan view of the right-side tool holder clamp movable jaw.

FIG. 9 is side elevational view thereof.

FIG. 10 is a bottom plan view thereof.

FIG. 11 is a front elevational view of the tool holder clamp of the invention with a tool holder positioned therein mounted on a magazine configuration shown in broken lines.

FIG. 12 is a top plan view thereof.

### DETAILED DESCRIPTION OF THE INVENTION

The figures and descriptions illustrate a preferred embodiment of the disclosure. It will be evident to those skilled in the art that various arrangements that although not typically described or shown herein embody principles of the disclosure are included in the scope of disclosure.

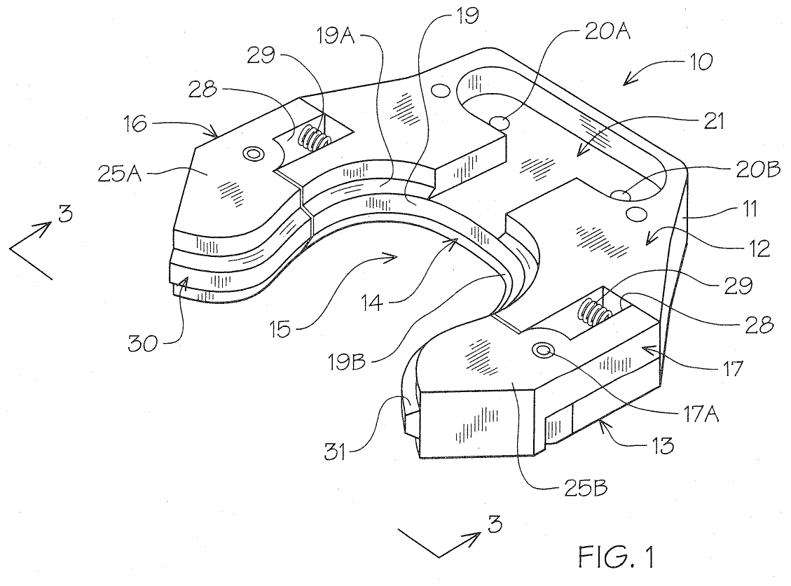

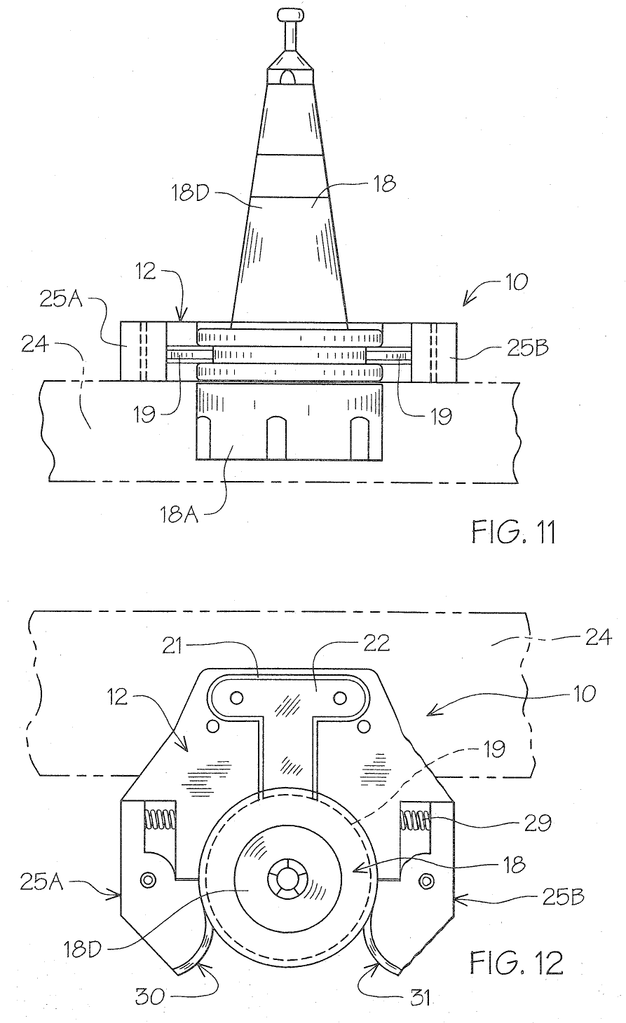

Referring now to FIGS. 1, 2 and 3 of the drawings, a tool holder clamp 10 of the invention can be seen having a main body member 11 with a top surface 12, a bottom surface 13 and a front bifurcated recessed surface 14 defining an arcuate tool holder receiving area 15 with a pair of oppositely disposed armatures 16 and 17 for support engagement and retention of a tool holder 18, best seen in FIGS. 11 and 12 of the drawings.

The armatures 16 and 17 have a contoured tool holder registration flange 19 there about with a tapered upper and lower surface 19A and 19B that allows for secure engagement with the tool holder 18 as will be disclosed and described in detail hereinafter.

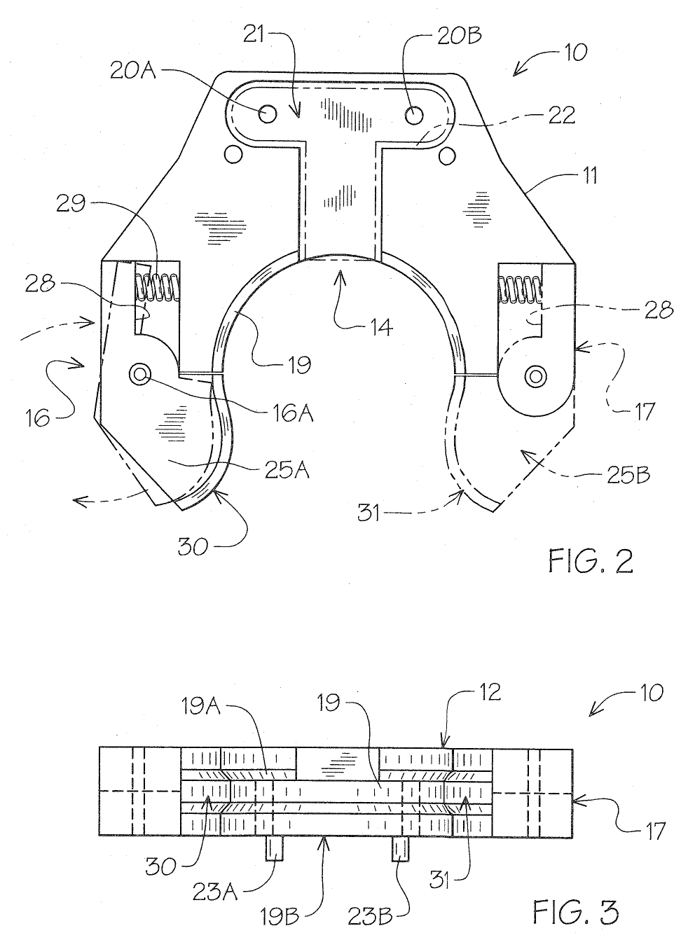

A pair of mounting apertures 20A and 20B extend through the tool holder clamp's main body member 11 within a T-shaped recess area 21 in the top surface 12. A holder registration engagement plate 22 shown in broken lines in FIG. 2 of the drawings and in solid lines in FIG. 13 of the drawings is positioned within the recess 21 and extends into the contoured tool holding receiving area 15 and acts as a registration stop for the tool holder when inserted therein.

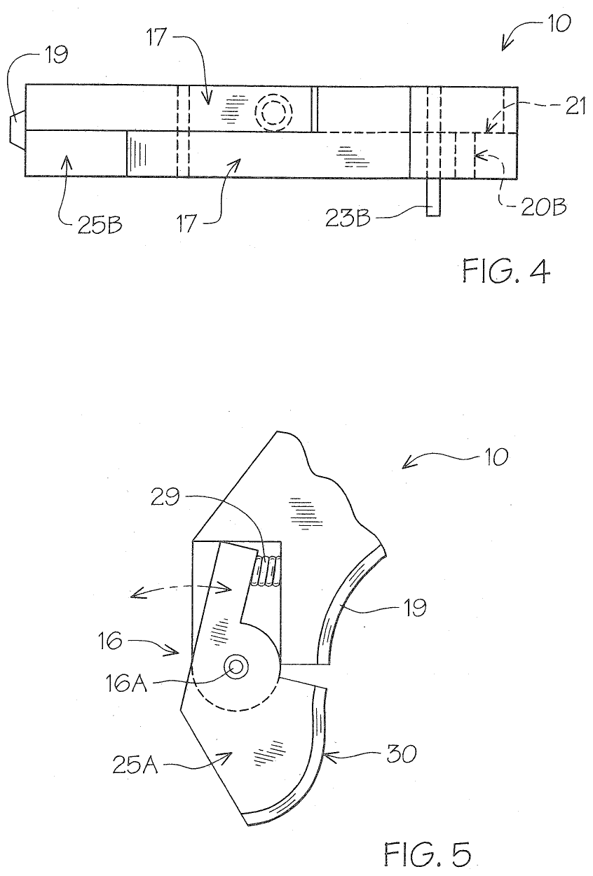

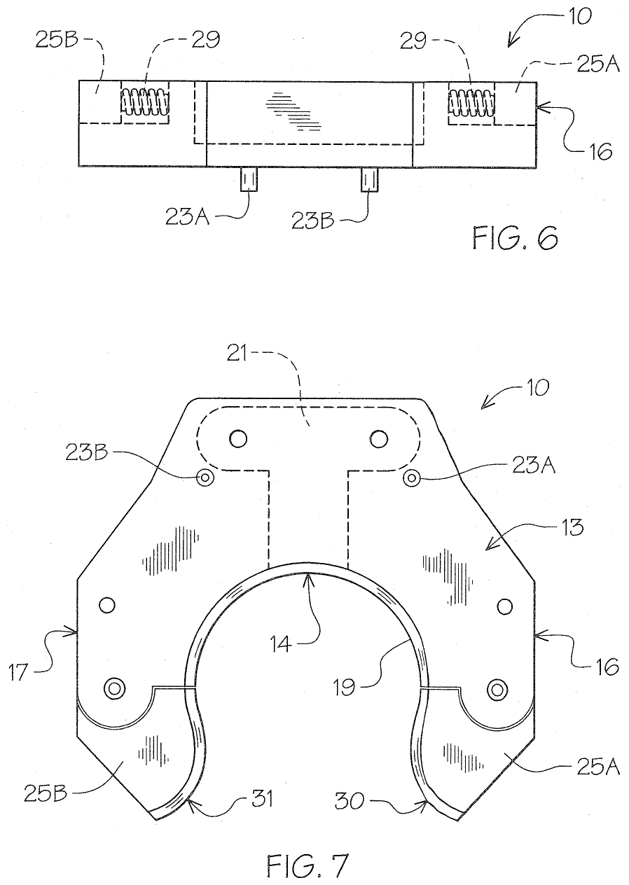

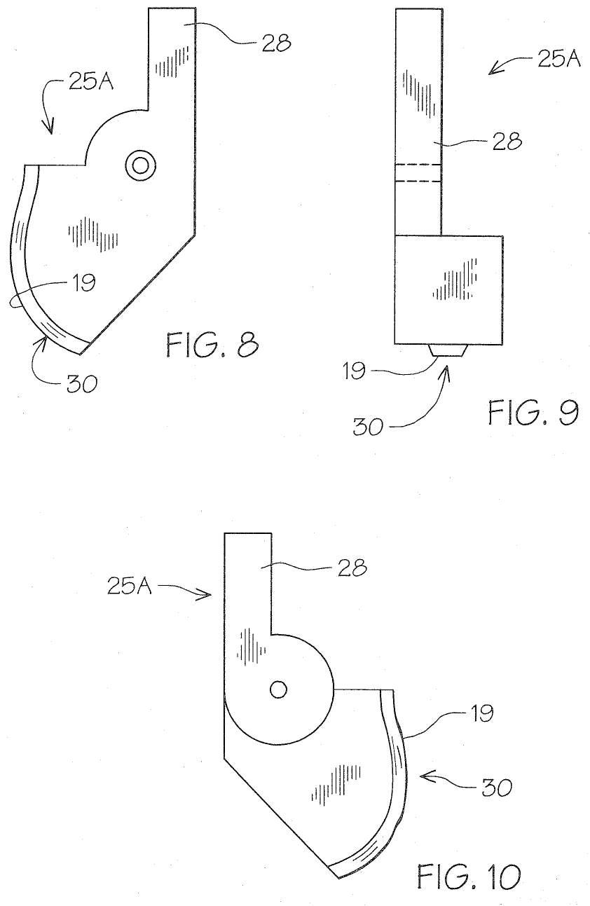

A pair of cylindrical registration alignment pins 23A and 23B extend from the bottom surface 13 as seen in FIG. 6 of the drawings of the main body member 11 in angularly offset alignment with the hereinbefore described mounting apertures 20A and 20B. The pins 23A and 23B provide positional registration alignment of the tool holder clamp 10 in a tool holder magazine 24 illustrated in FIGS. 11 and 12 of the drawings in broken lines. Each of the main body member armatures 16 and 17 have movable jaws 25A and 25B respectively pivotally secured on the corresponding free ends of the jaws as seen in FIGS. 1, 2, 5 and 7 of the drawings and each have an apertured recess pivoted surface 26 with a spring engagement lever portion 28 extending therefrom. The respective jaws 25A and 25B are mirror images of one another for oppositely disposed placement and are pivotally secured to the respective armatures 16 and 17 by pivot pins 16A and 17A providing therefore a pair of opposing resilient pivoting tool holder engagement surfaces. Each of the jaws 25A and 25B has a spring 29 registered between their extending lever portion 28 and the respective armature surfaces 16B and 17B which allows for resilient pivoted deflection of the respective opposing jaws 25A and 25B indicated by directional broken arrows A. Each of the jaws 25A and 25B have a contoured tool holder registration flange 30 and 31 that registerably aligns with the hereinbefore disclosed armature registration flange 19 defining a continuous half arcuate engagement surface within the tool holder's engagement area 15.

The tool holder 18 for the CNC milling machines is well known in the art and has cutting tools retainment cullet 18A with an annular clamping retainment channel 18B and a conically extending indexing engagement collar 18D.

In use, multiple tool holder clamps 10 are mounted on the tool magazine 24. As the tool holder 18 is engaged, removed, and reinserted in the tool holder clamp 10 of the invention during automated cutting tool usage by the respective spring pivoted jaws 25A and 25B yieldingly engage and disengage the tool holder 18 while maintaining the precise indexing position and orientation required for the tool holder to be properly accessed by the automated CNC machine.

It will be evident, therefore, that the tool holder clamp 10 of the present invention due to its opposing resilient jaw's orientation diminishes effective wear on the tool holder clamp thus improving longevity while maintaining quality retainment of the tool holder as required.

It will be evident to those skilled in the art, as noted, that various changes and modifications may be made therein without departing from the spirit of the invention, therefore I claim:

1. A tool holder clamp for pre-positioning milling tools for automatic loading in a CNC controlled milling machine comprising,
an integrated bifurcated support body,
a pair of armatures extending from said support body defining a tool holder engagement area there between,
a spring urged tool holder engagement jaw on said respective armatures,
a contoured registration flange on said tool holder engagement armatures and said respective movable tool holder engagement jaws in aligned planar orientation with one another.

2. The tool holder clamp set forth in claim 1 wherein said support body has a recess area configured to receive a tool holder registration plate there within.

3. The tool holder clamp set forth in claim 1 wherein said armatures are configured to receive said respective movable tool holder engagement jaws in overlapping pivoted relationship thereon.

4. The tool holder clamp set forth in claim 1 wherein said movable tool holder jaws extend partially from the free ends of said respective support armatures in said oppositely disposed relation to one another.

5. The tool holder clamp set forth in claim 1 wherein said contoured holder engagement flange on said respective armatures define a fixed arcuate tool holder engagement surface.

6. The tool holder clamp set forth in claim 1 wherein said contoured holder registration flange on said movable respective engagement jaws defines opposing convex tool holder engagement surfaces.

7. The tool holder set forth in claim 1 wherein said movable holder engagement jaws are movable from a first end alignment with said registration flange on said respective armatures to a second position in spaced planar relation thereto.

8. The tool holder clamp set forth in claim 1 wherein said bifurcated support body and said respective movable holder engagement jaws are formed from synthetic resin material.
